(19) United States
(12) Patent Application Publication
(10) Pub. No.: US 2009/0246594 A1
(43) Pub. Date: Oct. 1, 2009

(54) FUEL CELL PIPING STRUCTURE

(76) Inventors: Yasunobu Jufuku, Shizuoka (JP); Miho Kizuki, Shizuoka (JP); Hiroyuki Nakamura, Shizuoka (JP)

Correspondence Address: KENYON & KENYON LLP, 1500 K STREET N.W., SUITE 700, WASHINGTON, DC, 20005, US

(21) Appl. No.: 12/305,703

(22) PCT Filed: Jun. 5, 2007
(86) PCT No.: PCT/JP2007/061688

§ 371 Date: Dec. 19, 2008

(30) Foreign Application Priority Data
Jun. 21, 2006 (JP) 2006-170917

(51) Int. Cl. H01M 2/02

(52) U.S. Cl. 429/34

(57) ABSTRACT

It is possible to appropriately assure insulation between a reactant gas piping and another part in a fuel cell case. In order to achieve this object, there is provided a fuel cell piping structure in which when arranging a reactant gas piping in a case (C) containing a fuel cell and a high-voltage part, a resin pipe is used as a part of the reactant gas piping. It is preferable that the resin pipe be used for the reactant gas piping in the vicinity of the high-voltage part. Moreover, it is preferable that the resin pipe be formed in a curved shape.

### BACKGROUND OF THE INVENTION

1. Field of the Invention

The present invention relates to a piping structure of a fuel cell. More particularly, the present invention relates to the improvement of a structure of a case containing a fuel cell and the like.

2. Description of Related Art

As a fuel cell (e.g., a solid polymer type fuel cell), a plurality of cells each including an electrolyte sandwiched between separators are laminated so that a predetermined voltage can be output. Moreover, a case containing such a fuel cell is sometimes provided with a high-voltage part such as a relay (e.g., see Patent Documents 1, 2).

[Patent Document 1] Japanese Patent Application Laid-Open No. 2002-367666

[Patent Document 2] Japanese Patent Application Laid-Open No. 2002-362165

### SUMMARY OF THE INVENTION

Such a fuel cell is connected to a pipe for supplying or discharging any type of reactant gas such as an oxidizing gas, a fuel gas or a reacted off gas. However, when the fuel cell is contained in a case as described above, insulation between a piping of any type of reactant gas and another part in the case is sometimes not sufficiently considered.

To solve the problem, an object of the present invention is to provide a fuel cell piping structure capable of appropriately assuring insulation between a reactant gas piping and another part in a case.

To achieve such an object, the present inventor has performed various investigations. When, for example, several hundred cells are laminated to realize an output voltage of about several hundred volts, not only a part such as the above relay but also the pipe of any type of reactant gas connected to the fuel cell can be regarded as high-voltage parts. In this case, this also needs to be investigated in a case where the insulation between the reactant gas piping and the other parts is taken into consideration. The present inventor who further has investigated this respect obtains an idea for solving such a problem, that is, an idea for appropriately assuring the insulation.

The present invention has been developed based on such an idea, there is provided a piping structure in which when arranging a reactant gas piping in a case containing a fuel cell and another high-voltage part, a resin pipe is used as a part of the reactant gas piping.

When the high output voltage is realized in the fuel cell, the reactant gas piping connected to the fuel cell has a state equivalent to that of the high-voltage part, and the insulation needs to be assured. In this respect, in the piping structure of the present invention in which the resin pipe is used in at least a part of the reactant gas piping, an insulation distance and a creepage distance are easily assured in a resin pipe portion. In consequence, the insulation between the reactant gas piping and the other parts can appropriately be assured.

Moreover, in general, the pipe made of a resin has flexibility larger than that of a pipe made of a metal or the like. Therefore, when at least a part of the reactant gas piping is the resin pipe, the flexibility of the whole piping improves as much as the part. In consequence, assembly properties improve in a case where a long reactant gas piping is handled, and operability accordingly advantageously improves.

In such a fuel cell piping structure, the resin pipe is preferably used in the vicinity of the high-voltage part. Moreover, the resin pipe is more preferably used in at least a portion of the reactant gas piping which passes through the vicinity of the corner of the high-voltage part and which has the minimum distance from the high-voltage part. In a case where the resin pipe is arranged in a portion in which the insulation distance between the reactant gas piping and the high-voltage part is not easily assured or in the vicinity of the portion, the insulation is easily assured. Moreover, in a case where the resin pipe is arranged in a portion in which the reactant gas piping might interfere with the high-voltage part or in the vicinity of the portion, even if the interference occurs, the insulation can be assured.

Moreover, the reactant gas piping is constituted of a rubber hose and a metal pipe, and a hose clip to attach the rubber hose to the metal pipe is preferably arranged so as to assure an insulation distance between the same and the other parts in the case. In general, the hose clip frequently made of the metal can minimize the insulation distance (the creepage distance) between the metal pipe and the high-voltage part in a case where the hose clip is applied to a portion in which the rubber hose is attached to the metal pipe. Moreover, the hose clip is sometimes arranged in a position close to the high-voltage part, the pipe or the like as the case may be. In this respect, when the hose clip is arranged so as to assure the insulation distance as in the present invention, appropriate insulation can be assured. For example, the hose clip is arranged in a position where the total value of the thickness of the rubber hose and the distance from the end face of the rubber hose to the hose clip is in excess of a predetermined circular face distance.

Furthermore, the resin pipe is preferably formed in a curved shape. When the pipe is deflected or bent, the flexibility of the whole piping improves, and an operation for assembling the pipe or the like can easily be followed.

Moreover, the present invention is suitable even for a case where the reactant gas piping has branched manifolds and at least two distal ends of the manifolds are attached to the same plane as that of the high-voltage part.

### BRIEF DESCRIPTION OF THE DRAWINGS

FIG. 1 is a diagram showing a schematic constitution of a fuel cell system in the present embodiment;

FIG. 2 is a perspective view showing one example of a constitution of a fuel cell;

FIG. 3 is a schematic diagram for explaining a piping structure of the fuel cell in the present embodiment;

FIG. 4 is a diagram showing a piping structure in which manifolds branched from a reactant gas piping are attached to the same plane as that of a high-voltage part;

FIG. 5 is a schematic diagram showing one example of the reactant gas piping which is constituted of a rubber hose and a metal pipe and to which hose clips are attached;

FIG. 6 is a diagram showing an enlarged connecting portion between the rubber hose and the metal pipe shown in FIG. 5; and

FIG. 7 is a sectional view cut along the VII-VII line of FIG. 5.

### DETAILED DESCRIPTION OF PREFERRED EMBODIMENT

A preferable embodiment of the present invention will hereinafter be described with reference to the drawings.

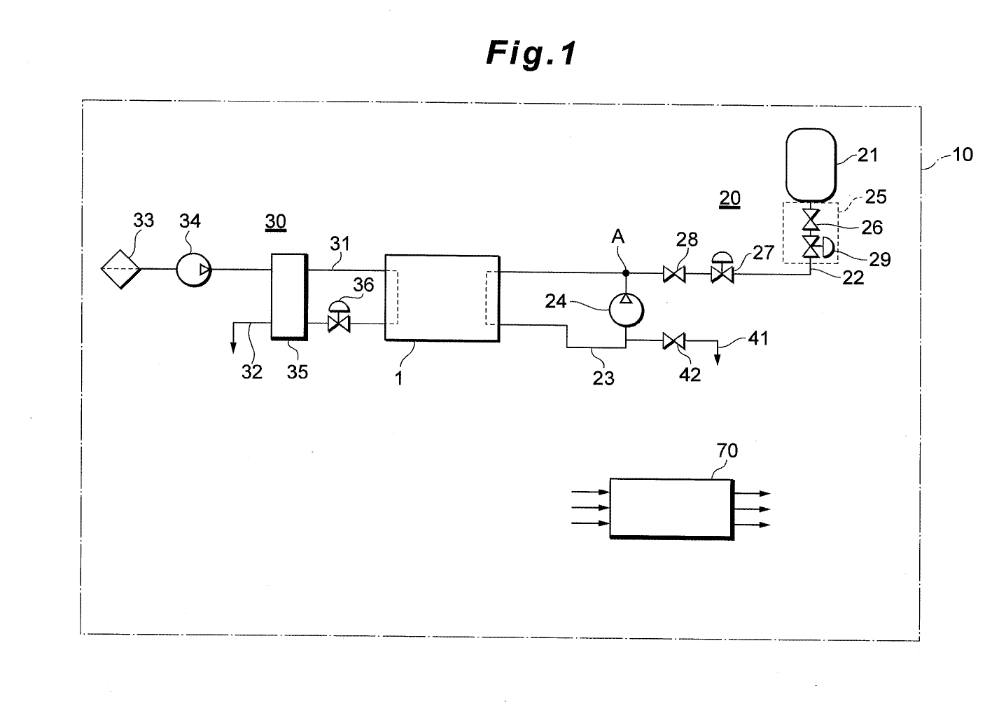

FIGS. 1 to 7 show the embodiment of a piping structure of a fuel cell according to the present invention. In this piping structure, a reactant gas piping is arranged in a case C in which a fuel cell 1 and another high-voltage part HV are arranged, and in the present embodiment, a resin pipe R is used in a part of the reactant gas piping (see FIG. 3, etc.).

First, the whole constitution of a fuel cell system 10, and the constitution of the fuel cell I will hereinafter be described, and then a constitution for assuring an insulation distance between the reactant gas piping and the high-voltage part HV will be described.

First, the fuel cell system 10 of the present embodiment will schematically be described (see FIG. 1). This fuel cell system 10 is constituted as a system including the fuel cell 1, an oxidizing gas piping system 30 which supplies air (oxygen) as an oxidizing gas to the fuel cell 1; a fuel gas piping system 20 which supplies a hydrogen gas as a fuel gas to the fuel cell 1; and a control unit 70 which generally controls the whole system.

The fuel cell 1 is constituted of, for example, a solid polymer electrolytic type, and includes a stack structure in which a large number of cells 2 are laminated. Each cell 2 constituting the fuel cell 1 has an air pole on one surface of an electrolyte constituted of an ion exchange film, and a fuel pole on the other surface thereof, and further has a pair of separators so that the air pole and the fuel pole are held between both sides. The fuel gas is supplied to a fuel gas passage of one of the separators, and the oxidizing gas is supplied to an oxidizing gas passage of the other separator. The gases are supplied in this manner to generate a power in the fuel cell 1.

The oxidizing gas piping system 30 has a supply path 31 through which the oxidizing gas to be supplied to the fuel cell 1 flows, and a discharge path 32 through which an oxidizing off gas discharged from the fuel cell 1 flows. The supply path 31 is provided with a compressor 34 which takes the oxidizing gas via a filter 33, and a humidifier 35 which humidifies the oxidizing gas fed under pressure by the compressor 34. The oxidizing off gas flowing through the discharge path 32 flows through a back pressure adjustment valve 36 for use in water content exchange in the humidifier 35, and then the gas is finally discharged as an exhaust gas to the atmosphere outside the system.

The fuel gas piping system 20 has a high-pressure hydrogen tank (referred to as a high-voltage tank in the present description) 21 as a fuel supply source; a supply path 22 through which a hydrogen gas to be supplied from the high-voltage tank 21 to the fuel cell 1 flows; a circulation path 23 which returns a hydrogen off gas (a fuel off gas) discharged from the fuel cell 1 to a joining part A of the supply path 22; a pump 24 which feeds the hydrogen off gas under pressure from the circulation path 23 to the supply path 22; and a discharge path 41 branched and connected to the circulation path 23.

The high-voltage tank 21 is constituted so that, for example, 35 MPa or 70 MPa of hydrogen gas can be stored. When a main stop valve 26 of the high-voltage tank 21 is opened, the hydrogen gas flows out to the supply path 22. Afterward, the flow rate and pressure of the hydrogen gas are adjusted by a regulator valve 29, and then on a further downstream side, the hydrogen gas has a pressure finally reduced into, for example, about 200 kPa by a pressure reduction valve such as a mechanical regulator valve 27, and is supplied to the fuel cell 1. The main stop valve 26 and the regulator valve 29 are incorporated in a valve assembly 25 shown by a broken frame line in FIG. 1, and the valve assembly 25 is connected to the high-voltage tank 21.

A blocking valve 28 is provided on the upstream side of the joining part A of the supply path 22. The circulation system of the hydrogen gas is constituted by connecting a downstream-side passage of the joining part A of the supply path 22, a fuel gas passage formed in the separator of the fuel cell 1 and the circulation path 23 in this order. A purge valve 42 of the discharge path 41 is appropriately opened during the operation of the fuel cell system 10 to discharge impurities in the hydrogen off gas to a hydrogen diluter (not shown) together with the hydrogen off gas. When the purge valve 42 is opened, the concentration of the impurities in the hydrogen off gas of the circulation path 23 decreases, and the concentration of the hydrogen in the hydrogen off gas to be circulated and supplied increases.

The control unit 70 is constituted as a micro computer including therein a CPU, an ROM and an RAM. The CPU executes desired computation in accordance with a control program to perform various types of processing and control, for example, the control of the flow rate of the regulator valve 29. The ROM stores the control program and control data to be processed by the CPU. The RAM is used as any type of operation region mainly for control processing. The control unit 70 inputs detection signals of various types of pressure and temperature sensors for use in the gas systems (20, 30) and a refrigerant system (not shown), to output control signals to constituting elements.

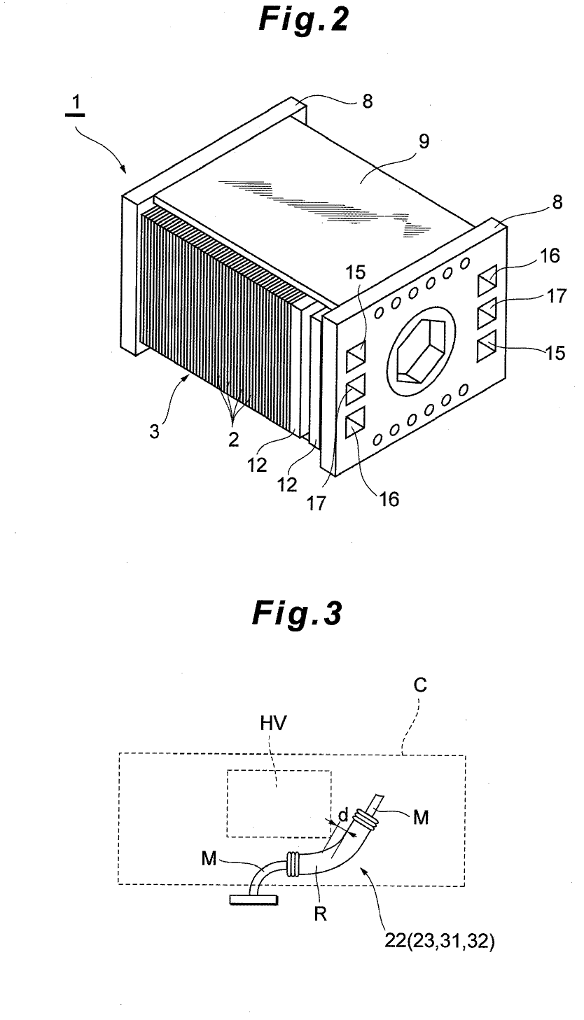

Moreover, a constitution of the fuel cell 1 will hereinafter briefly be described (see FIG. 2).

The fuel cell 1 in the present embodiment has a cell laminate 3 in which a plurality of cells 2 are laminated, and a collector plate provided with an output terminal, an insulation plate and an end plate 8 are successively arranged outside each of the cells 2, 2 positioned at both ends of the cell laminate 3 (see FIG. 2). The cell laminate 3 is bound in a laminated state by a tension plate 9. The tension plate 9 is provided so as to bridge a space between both the end plates 8 and 8. For example, a pair of tension plates are arranged so as to face both the sides of the cell laminate 3. Moreover, an elastic module for exerting a compressive force to the cell laminate 3 by an elastic force is further provided. The elastic module is a member for continuously exerting a load while absorbing a change even in a case where the cell laminate 3 thermally expands, thermally contracts, or repeats both the thermal expansion and the thermal contraction. In the present embodiment, the module is constituted of a plurality of elastic members (not shown) arranged in parallel with one another, a pair of pressure plates 12 which sandwich the plurality of elastic members therebetween from the laminating direction of the cells 2 and the like (see FIG. 2). Furthermore, manifolds 15 for an oxidizing gas, manifolds 16 for a hydrogen gas and manifolds 17 for cooling water are formed in the fuel cell 1, respectively.

Next, the piping structure of the present embodiment configured to appropriately assure the insulation distance between the reactant gas piping and the high-voltage part HV (see FIG. 3, etc.).

This piping structure is configured to dispose the reactant gas in the case (the fuel cell case) C in which the fuel cell 1 as the high-voltage part HV and another high-voltage part HV are arranged. The reactant gas piping mentioned herein is a piping for supplying the reactant gas to the fuel cell 1 or discharging the off gas or the like from the fuel cell 1, and the piping corresponds to, for example, the supply path 31 through which the oxidizing gas flows as shown in FIG. 1, the discharge path 32 through which the oxidizing off gas flows, the supply path 22 through which the hydrogen gas flows, the circulation path 23 through which the hydrogen off gas (the fuel off gas) flows and the like (see FIG. 1). The reactant gas piping 22 (23, 31 and 32) is, in principle, constituted of a metal pipe made of, for example, SUS, and one end of each pipe is arranged in the fuel cell 1 (more specifically, so that the pipes communicate with the respective manifolds 15, 17 formed in the fuel cell 1).

Here, in the present embodiment, the resin pipe R is used in a part of the above reactant gas piping 22 (23, 31 and 32) (see FIG. 3). In this case, the resin pipe R is preferably used in the reactant gas piping 22 (23, 31 and 32) in the vicinity of the high-voltage part HV. In a case where the resin pipe R is used as a pipe in a portion between the reactant gas piping 22 (23, 31 and 32) and the high-voltage part HV in which the insulation distance is not easily assured, or in the vicinity of the portion, insulation is easily assured. Moreover, in a case where the resin pipe R is used in a portion in which the reactant gas piping 22 (23, 31 and 32) might interfere with the high-voltage part HV or in the vicinity of the portion, even if the interference occurs, the insulation is advantageously assured. For example, in the present embodiment, the resin pipe R is used in a piping portion which passes through the vicinity of the corner of the high-voltage part HV (e.g., the fuel cell 1 itself) and which has a minimum distance d from the high-voltage part HV (see FIG. 3).

According to the piping structure of the present embodiment in which the resin pipe R is used in a part of the reactant gas piping 22 (23, 31 and 32) in this manner, the insulation distance larger than ever can be assured between the portion of the metal pipe (denoted with symbol M in the drawing) of the reactant gas piping 22 (23, 31 and 32) and the high-voltage part HV. This is especially preferable in that the insulation is easily assured, for example, in a case where various parts and pipes are densely disposed in the case C.

Moreover, a pipe made of a resin generally has flexibility larger than that of a pipe made of a metal, and hence the pipes can be assembled using the flexibility in a case where the resin pipe R is used in a part of the reactant gas piping 22 (23, 31 and 32) as described above. That is, the portion of the resin pipe R can function like a flexible pipe, so that the pipes are easily assembled to improve operability as compared with a case where the whole piping is made of the metal.

Furthermore, in the piping structure of the present embodiment, a part of the metal pipe M is made of the resin, whereby the thermal capacity of the whole piping is decreased, and the thermal conductivity of the corresponding portion is also decreased. In consequence, even at, for example, a low temperature, water formed in an outlet-side piping is prevented from being frozen, and flow is easily assured. Additionally, in the piping structure of the present embodiment in which the resin pipe R having the flexibility as described above is used, even if the water in the piping freezes, volume expansion is absorbed by the resin pipe R, and an influence on the metal pipe M can be decreased.

There is not any special restriction on the material of the resin pipe R described above, and any type of engineering plastic material, or a synthetic resin, for example, polypropylene having excellent resistances to reagent, flexural fatigue and heat may be used.

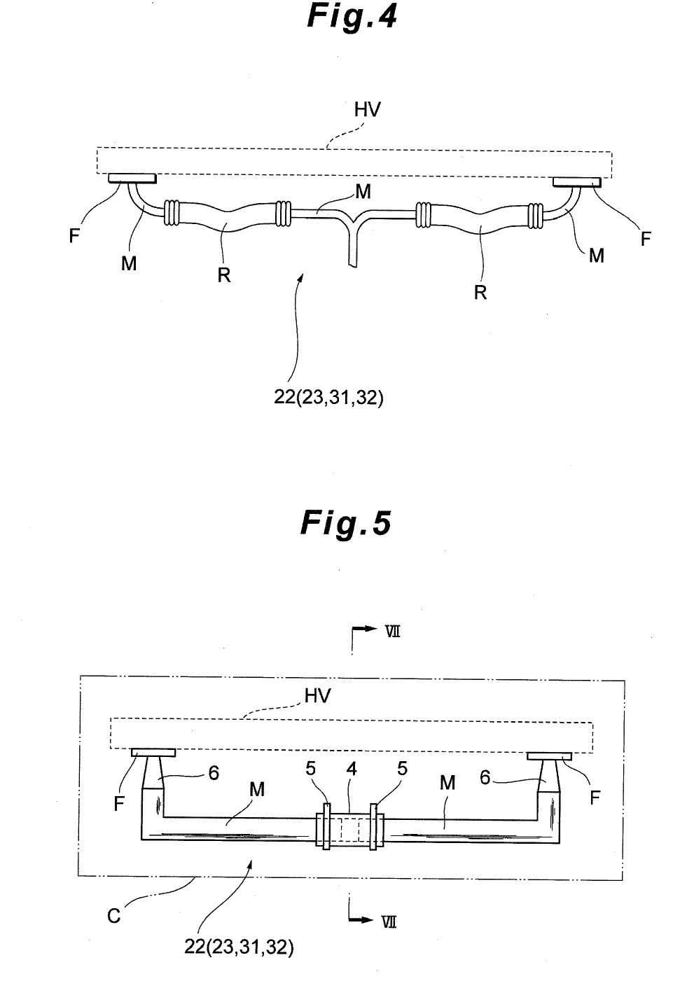

Moreover, based on the above-mentioned flexibility of the resin pipe R, the piping structure may be configured to suppress leakage from a flange face or the like. Specifically, the resin pipe R described above is preferably used in a case where the reactant gas piping 22 (23, 31 and 32) is provided with manifolds branched halfway as shown in, for example, FIG. 4, and flange portions F at both the distal ends of the manifolds are attached to the same plane as that of the high-voltage part HV. That is, when a long integral pipe is prepared, the parallelism of the flange portions F cannot be assured owing to the influence of a welding or pressing error, and even the leakage of a fluid from the flange portions F occurs as the case may be. However, when the resin pipe R is applied to impart the flexibility to the piping, the parallelism can easily be assured. In such a case, the respective manifolds can securely be attached to the high-voltage part HV in the flange portions F, to suppress the fluid leakage, and additionally the operability advantageously improves. Moreover, in the piping structure, since a part of the metal pipe M is made of the resin or the like, the thermal capacity of the whole piping can be decreased.

In addition, from a viewpoint that the flexibility of the reactant gas piping 22 (23, 31 and 32) be further increased, it is preferable to use the resin pipe R having a curved shape such as a deflected or bent shape. In such a case, the flexibility of the whole piping can accordingly be improved (see FIG. 4).

Moreover, even in a case where the reactant gas piping 22 (23, 31 and 32) is constituted of, for example, a rubber hose 4 and the metal pipe M and a hose clip 5 is used in attaching the rubber hose 4 to the metal pipe M, the insulation between the reactant gas piping 22 (23, 31 and 32) and another part (including the case C itself) in the case C can preferably appropriately be assured. An example will hereinafter be described (see FIGS. 5 to 7).

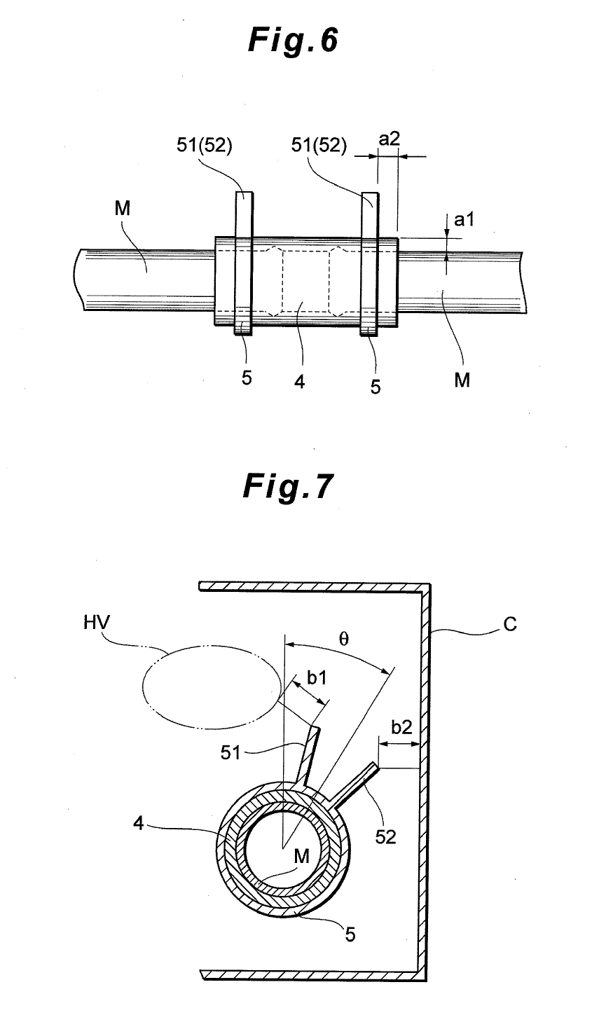

As one example, in a piping structure shown in FIG. 5, the ends of metal pipes M made of SUS or the like are connected to each other via a rubber hose 4. Moreover, hose clips 5 are attached to portions of the rubber hose 4 which cover the metal pipes M, so that the rubber hose is attached in a state in which any fluid leakage does not occur (see FIGS. 5, 6).

Here, in the present embodiment, the hose clips 5 are attached in consideration of the insulation distance (the creepage distance) between the metal pipes M and the high-voltage part HV. That is, when the hose clips 5 made of the metal are used in a portion where the rubber hose 4 is attached to the metal pipes M, the hose clips can be interposed between the metal pipes M and the high-voltage part HV to decrease the insulation distance (the creepage distance) between them. In this respect, when the hose clips 5 are arranged so as to assure a sufficient insulation distance in the present embodiment, the insulation between the metal pipes M and the high-voltage part HV can be assured.

This example will specifically be described. In the present embodiment, the attachment positions of the hose clips 5 are determined in consideration of the creepage distance required for the insulation. That is, first an insulation creepage distance (a) required between the metal pipe M and the hose clip 5 is calculated, and then the total value of a thickness (a1) of the rubber hose 4 and an attachment offset amount (a distance from the end face of the rubber hose 4 to the hose clip 5) (a2) of the hose clip 5 is set to a value in excess of the required insulation creepage distance (a) (a1+a2>a) (see FIG. 6). That is, in the present embodiment, the hose 5 is arranged so as to be positioned on the inner side of the end face of the rubber hose 4, so that the necessary insulation creepage distance (a) is assured.

Moreover, the attachment angle of the hose clip 5 is further preferably taken into consideration (see FIG. 7). That is, in a case where the hose clip 5 is provided with a pair of finger grips 51, 52 so that the grips extend in a V-shaped manner, the hose clip 5 is arranged in consideration of a clearance between the high-voltage part HV or the inner surface of the case C and the finger grips 51, 52. A specific example will be described. When a clearance between the distal end of the one finger grip 51 and the high-voltage part HV is b1 and a clearance between the distal end of the other finger grip 52 and the inner surface of the case C is b2, an attachment angle θ of the hose clip 5 is adjusted to determine the distances b1 and b2 in excess of a necessary clearance (a). It is to be noted that when the one clearance b1 is enlarged, the other clearance b2 sometimes narrows. Therefore, the attachment angle θ needs to be adjusted in consideration of the enlarging/narrowing of both the clearances b1, b2 (see FIG. 7).

In a case where the attachment offset amount (a2) and the attachment angle θ of the hose clip 5 are determined in consideration of the creepage distance and the clearances as described above, appropriate insulation can be assured in a state in which the hose clip 5 is installed. Moreover, in the actual fuel cell 1, individual differences might be generated in the shape of the rubber hose 4, the shape and arrangement of the reactant gas piping 22 (23, 31 and 32), the size of the hose clip 5 and the like, but the above technique is applicable to each fuel cell 1 or each fuel cell system 10, and hence these errors of the parts or the like can be absorbed to individually assure the appropriate insulation.

In addition, reference numeral 6 in FIG. 5 is a so-called molded pipe made of SUS or the like and formed so as to connect sections having different shapes to each other, for example, connect a circular section to a rectangular section. In general, the manufacturing cost of the molded pipes easily increases, and hence the same mold is preferably used in common for the molded pipes from the viewpoint of the cost. In this respect, according to the piping structure of the present embodiment, the piping can be configured while absorbing the processing errors of the welding, pressing and the like of the reactant gas piping 22 (23, 31 and 32). Therefore, the versatility of the molded pipes 6 can be improved to decrease the cost. Moreover, in the present embodiment, the same molded pipe 6 can be used in common on left and right sides, which is further advantageous.

It is to be noted that the above embodiment is one example of the preferable embodiment of the present invention, but the present invention is not limited to this example, and can variously be implemented without departing from the scope of the present invention. For example, in the present embodiment, as the reactant gas piping, the supply path 31 through which the oxidizing gas flows, the discharge path 32 through which the oxidizing off gas flows, the supply path 22 through which the hydrogen gas flows and the circulation path 23 through which the hydrogen off gas (the fuel off gas) flows have been illustrated, but these pipes are merely illustrated. That is, the above constitution also applies to any type of pipe such as a pipe for cooling water (not shown) from viewpoints that the pipe is electrically connected to the fuel cell 1 as the high-voltage part HV and that the pipe itself constitutes a part of the high-voltage part HV. In such a case, the present invention can be applied to this pipe for the cooling water in the same manner as in the present embodiment.

### INDUSTRIAL APPLICABILITY

According to the present invention, it is possible to appropriately assure an insulation distance between a reactant gas piping and a high-voltage part in a case.

In consequence, the present invention is broadly usable in such a demanded fuel cell piping structure.

1. A piping for a fuel cell comprising a structure in which, when arranging a reactant gas piping in a case containing a fuel cell and another high-voltage part, a resin pipe is used as a part of the reactant gas piping to assure insulation between the reactant gas piping and the other part in the fuel cell case.

2. The piping for the fuel cell according to claim 1, wherein the resin pipe is used for the reactant gas piping in the vicinity of the high-voltage part.

3. The piping for the fuel cell according to claim 2, wherein the resin pipe used in at least a portion of the reactant gas piping which passes through the vicinity of the corner of the high-voltage part and which has the minimum distance from the high-voltage part.

4. The piping for the fuel cell according to claim 1, wherein the reactant gas piping is constituted of a rubber hose and a metal pipe, and a hose clip to attach the rubber hose to the metal pipe is arranged so as to assure an insulation distance between the same and the other part in the fuel cell case.

5. The piping for the fuel cell according to claim 4, wherein the hose clip is arranged in a position in which the total value of the thickness of the rubber hose and a distance from the end face of the rubber hose to the hose clip is in excess of a creepage distance.

6. The piping for the fuel cell according to claim 3, wherein the resin pipe is formed in a curved shape.

7. The piping for the fuel cell according to claim 3, wherein the reactant gas piping has branched manifolds, and at least two distal ends of the manifolds are attached to the same plane as that of the high-voltage part.

8. The piping for the fuel cell according to claim 5, wherein the resin pipe is formed in a curved shape.

9. The piping for the fuel cell according to claim 5, wherein the reactant gas piping has branched manifolds, and at least two distal ends of the manifolds are attached to the same plane as that of the high-voltage part.
